(19) United States
(12) Patent Application Publication
(10) Pub. No.: US 2026/0272212 A1
(43) Pub. Date: Sep. 17, 2026

(54) APPARATUS AND METHODS FOR STEEPING TEA

(71) Applicant: Happy Loose Leaf Tea Inc., South Jordan, UT (US)

(72) Inventor: Noah Mechnig-Giordano, South Jordan, UT (US)

(21) Appl. No.: 19/473,132

(22) PCT Filed: Apr. 8, 2024
(86) PCT No.: PCT/US2024/023650

§ 371 Date: Oct. 6, 2025

Related U.S. Application Data
(60) Provisional application No. 63/494,769, filed on Apr. 6, 2023.

(51) Int. Cl. A47J 31/52; A23F 3/18; A47J 31/00; A47J 31/06

(52) U.S. Cl. CPC A47J 31/52; A23F 3/18; A47J 31/005; A47J 31/0615

(57) ABSTRACT

Apparatus and methods of use provide for steeping materials for a tea beverage or the like, wherein an apparatus in accordance with some embodiments comprises, a timer; a steeping material containing portion having an exterior configured to allow passage of liquid through the exterior of the steeping material containing portion; and a blocking portion configured (e.g., in coordination with the timer and/or the steeping material containing portion) to prevent the passage of liquid through the exterior of the steeping material containing portion.

### CROSS-REFERENCE TO RELATED APPLICATIONS

The present application claims the benefit of priority of U.S. Provisional Patent Application No. 63/494,769 filed Apr. 6, 2024, entitled “Apparatus and Methods for Steeping Tea,” which is incorporated by reference in the present application.

### FIELD OF THE INVENTION

The present invention is generally directed to apparatus and methods for steeping tea.

### BACKGROUND

Prior art devices for steeping tea leaves and other steeping material to make tea and similar beverages suffer from various disadvantages, including steeping the tea leaves too long or not long enough. They also do not provide a convenient method for portable and accurate tea steeping or preventing over and under brewing. Other prior art devices, for example, simply comprise a metal mesh basket reshaped or designed; however, they do not innovate to improve the tea steeping process or make it more portable. Prior art devices also are not optimized for being able to brew tea on the go. For example, some prior art solutions are bound to a steeper bottle or container and cannot be used flexibly in different vessels. Other prior art solutions focus on appearance and may provide home brewing solutions, but do not provide optimized functionality for portable tea brewing

### BRIEF DESCRIPTION OF THE DRAWINGS

An understanding of embodiments described in this disclosure and many of the related advantages may be readily obtained by reference to the following detailed description when considered with the accompanying drawings, of which:

FIG. 1 is a diagram of an example tea steeping device according to an embodiment of the present invention;

FIG. 2 is a diagram of an example configuration of a timing unit according to an embodiment of the present invention;

FIG. 3 is a diagram of an example configuration of a timing unit according to an embodiment of the present invention;

FIG. 4 is a diagram of an example timing unit assembly according to an embodiment of the present invention;

FIG. 5 is an exploded diagram of an example configuration of a timing unit according to an embodiment of the present invention;

FIG. 6 is a diagram of an example tea container according to an embodiment of the present invention;

FIG. 7 is an exploded diagram of an example tea container according to an embodiment of the present invention;

FIG. 8 is a diagram showing the filling of an example tea container of a tea steeping device according to an embodiment of the present invention;

FIG. 9 is a diagram of an example tea steeping device according to an embodiment of the present invention;

FIG. 10 is a diagram showing internal arrangement of some components of an example tea steeping device according to an embodiment of the present invention;

FIG. 11 is a diagram showing an example use of a tea steeping device in a vessel according to an embodiment of the present invention;

FIG. 12 is a diagram showing an example use of a tea steeping device in a vessel according to an embodiment of the present invention;

FIG. 13 is a diagram showing an example use of a tea steeping device in a vessel according to an embodiment of the present invention;

FIG. 14 is a diagram showing an example use of a tea steeping device in a vessel according to an embodiment of the present invention;

FIG. 15 is a diagram of an example timer unit base according to an embodiment of the present invention;

FIG. 16 is a diagram of an example bottom lid for a tea container according to an embodiment of the present invention;

FIG. 17 is a diagram of an example center shaft according to an embodiment of the present invention;

FIG. 18 is a diagram of an example center spring gear according to an embodiment of the present invention;

FIG. 19 is a diagram of an example timer gear according to an embodiment of the present invention;

FIG. 20 is a diagram of an example ratchet for use in a timer gear according to an embodiment of the present invention;

FIG. 21 is a diagram of an example timer gear with internal ratchet according to an embodiment of the present invention;

FIG. 22 is a diagram of an example tea container bottom according to an embodiment of the present invention;

FIG. 23 is a diagram of an example tea container top according to an embodiment of the present invention;

FIG. 24 is a diagram of an example main body of a tea steeping device according to an embodiment of the present invention;

FIG. 25 is a diagram of an example center gear guide according to an embodiment of the present invention;

FIG. 26 is a diagram of an example ratchet gear according to an embodiment of the present invention;

FIG. 27 is a diagram of an example seconds timer plate according to an embodiment of the present invention;

FIG. 28 is a diagram of an example top cap of a tea steeping device according to an embodiment of the present invention;

FIG. 29 is a diagram of an example timer unit top plate according to an embodiment of the present invention;

FIG. 30 is a diagram of an example assembled main body and tea container of an example tea steeping device according to an alternative embodiment of the present invention;

FIG. 31 is an exploded diagram of an example tea steeping device according to an alternative embodiment of the present invention;

FIG. 32 is a diagram showing an example use of a tea steeping device in a vessel according to an alternative embodiment of the present invention;

FIG. 33 is a diagram showing an example use of a tea steeping device in a vessel according to an alternative embodiment of the present invention;

FIG. 34 is a diagram showing an example use of a tea steeping device in a vessel according to an alternative embodiment of the present invention;

FIG. 35 is a diagram showing an example use of a tea steeping device in a vessel according to an alternative embodiment of the present invention;

FIG. 36 is a diagram of an alternative view of an example bottom lid for a tea container according to an embodiment of the present invention;

FIG. 37 is a diagram of an example tea container bottom according to an alternative embodiment of the present invention;

FIG. 38 is a diagram of an example tea container top according to an alternative embodiment of the present invention; and

FIG. 39 is a diagram of an example main body of a tea steeping device according to an alternative embodiment of the present invention;

### DETAILED DESCRIPTION

### A. Introduction

The present invention provides improvements over prior art practices and devices by providing, in accordance with some embodiments, a flexible solution that also makes tea steeping easier, more reliable, and more efficient.

Inventor for this application have recognized that, in accordance with some embodiments described in this disclosure, some types of drinkers of tea beverages and other types of beverages that require steeping leaves or other organic material in liquid may find it beneficial to have a steeping device that can close off the tea or other material from a beverage container to stop the tea steeping process.

Problems in the prior art with over and under steeping may be solved, in accordance with some embodiments, with a steeping device that rotates automatically to close off the steeping device or ball when a timer on the device finishes and/or that allows a user to rotate the device to close off the steeping device, thereby stopping the tea steeping process.

According to some embodiments, a user may select a time period for which they would like to steep the tea with a steeping device.

The steeping device is configured to ensure the tea leaves are able to infuse in the water (or other liquid) for only the desired period of time.

In one or more embodiments, a mechanical timer for a steeping device allows for precise tea steeping without the need for users to watch a timer and to then remove the steeping material (e.g., loose leaf tea) from their drink before they wish to drink it.

In one embodiment, a steeping device is fully portable and may be used in any container with precise timing and control over the steeping process.

This invention is an improvement as it is providing a flexible solution that also makes tea steeping easier, more reliable, and more efficient.

According to some embodiments, the inventive tea steeping device may be used with any vessel or container for containing liquid.

According to some embodiments, an apparatus for steeping materials for a tea beverage or the like comprises:
a) a timer;
b) a steeping material containing portion having an exterior configured to allow passage of liquid through the exterior of the steeping material containing portion; and
c) a blocking portion connected to the timer and configured to prevent the passage of liquid through the exterior of the steeping material containing portion.

In accordance with some embodiments of the present invention, one or more apparatus (e.g., a tea steeping device) for steeping materials for a tea beverage or the like comprise one or more of:
a) a mechanical or electromechanical timer (e.g., comprising a timer dial) configured to allow a user to set the timer for a desired period of time;
b) a steeping material containing portion having an exterior (e.g., of a permeable mesh material) configured to allow passage of liquid through the exterior of the steeping material containing portion; and/or
c) a blocking portion connected to the timer and configured with the timer to prevent the passage of liquid through the exterior of the steeping material containing portion by covering (e.g., incrementally) the exterior of the steeping material containing portion as the timer winds down.

According to some embodiments, the blocking portion and/or timer are in mechanical communication (via a connecting screw) with the steeping material containing portion and the timer is configured to rotate the connecting screw to advance the screw into a receiving shaft in accordance with expiration of a period timed by the timer, thereby drawing the steeping material containing portion within a corresponding receiving portion of the blocking portion, thereby (e.g., incrementally) preventing flow of water through a mesh portion of the steeping material containing portion.

According to some embodiments, an apparatus for steeping materials for a tea beverage or the like comprises:
a) a timer;
b) a steeping material containing portion connected to the timer and having an exterior configured to allow passage of liquid through the exterior of the steeping material containing portion; and
c) a blocking portion configured with the timer and the steeping material containing portion to prevent the passage of liquid through the exterior of the steeping material containing portion.

In accordance with some embodiments of the present invention, one or more apparatus (e.g., a tea steeping device) for steeping materials for a tea beverage or the like comprise one or more of:
a) a mechanical or electromechanical timer (e.g., comprising a timer dial) configured to allow a user to set the timer for a desired period of time;
b) a steeping material containing portion having an exterior (e.g., of a permeable mesh material) configured to allow passage of liquid through the exterior of the steeping material containing portion; and/or
c) a blocking portion configured with the steeping material containing portion and/or the timer to prevent the passage of liquid through the exterior of the steeping material containing portion by covering (e.g., incrementally) the exterior of the steeping material containing portion as the timer winds down.

According to some alternative embodiments, the timer and the steeping material containing portion are connected via a magnetic and/or mechanical connecting axle. The timer is configured to rotate the connecting axle to rotate the steeping material containing portion within a blocking portion having at least one opening allowing fluid communication to the interior of the steeping material containing portion. In one example, an exterior window or opening in the blocking portion allows for the flow of fluid into the steeping material containing portion when the window is aligned with an interior window or opening having a porous material (e.g., mesh) in the steeping material containing portion (e.g., at the start of a timed steeping session). As the timer runs it rotates the interior window of the steeping material containing portion away from the exterior window, reducing the exposure of any contained steeping material to the surrounding fluid. In this way, the tea steeping device (e.g., incrementally) prevents flow of water through a mesh portion of the steeping material containing portion. In one example, when the timer runs out, no portion of the interior window is accessible through the exterior window and fluid can no longer pass between the vessel through the exterior window and into the steeping material containing portion.

According to some embodiments, the apparatus further comprises a top lid or cover for securing the timer to the steeping device (e.g., to a top portion of the steeping device and/or to a mounting platform) and/or for containing one or more components of the timer.

According to some embodiments, the steeping material containing portion comprises a removable lid or cover for providing access to the interior of the steeping material containing portion, such as for placing steeping material (e.g., loose leaf tea) and/or for cleaning the steeping material containing portion.

Although various embodiments of the disclosed invention are described with respect to the making of tea and tea beverages, this invention could also be used to brew coffee or any other type of water-or liquid-based infusion. It could also be used to disperse or mix a substance within a hot or cold liquid. Accordingly, references to “tea” are not limiting and will be understood as contemplating as being applicable to other types of steeping material and other types of prepared beverages.

This invention may be used to produce boiled/warmed tea, coffee, or other substances, which could be used for composting or repurposed for other products.

Although various embodiments of the disclosed invention are described as having example means for blocking the passage of liquid to the interior of a steeping portion, wherein the blocking means are indicated as being exterior or surrounding the steeping portion, according to some alternative embodiments, the blocking means may alternatively or in addition be located on the interior of the steeping portion (e.g., to block from the inside passage of liquid into a steeping device).

According to some embodiments, any of the components may be constructed using materials suitable for steeping hot and/or cold beverages, including desirable characteristics for temperature and submersion in liquid. For example, components may be made of plastic, rubber, ceramic, wood, and/or metal, as deemed suitable for a desired implementation.

According to some embodiments, internal pins may be used to affix components of the tea steeping device, such as components of a timing unit, to receiving slots in the timing unit. In one embodiment, internal pins may be cut to size from brass or stainless steel with a suitable diameter (e.g., 1.55 mm).

According to one embodiment, a timer unit comprises an internal spring, as will be readily understood in the art. In some embodiments, the internal spring may be manufactured from a steel strip (e.g., 0.3 mm thick and 3 mm wide).

### B. General Systems and Structures

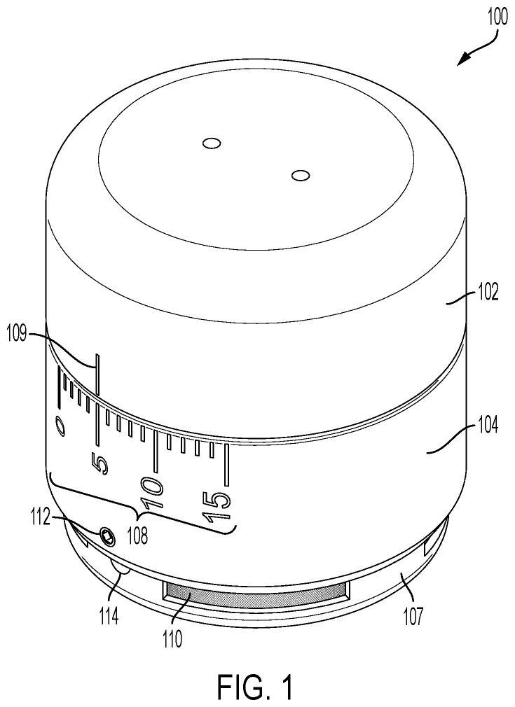

FIG. 1 is a diagram of an example tea steeping device 100 according to an embodiment of the present invention. The example tea steeping device comprises a top cap 102 that includes a timer indicator 109 and a housing or main body 104 that also includes indicia for a timer 108. As will be readily understood, the timer 108 may be set by aligning the timer indicator 109 with the desired number of minutes, such as by rotating the upper portion covered by the top cap 102 relative to the lower portion of the main body 104.

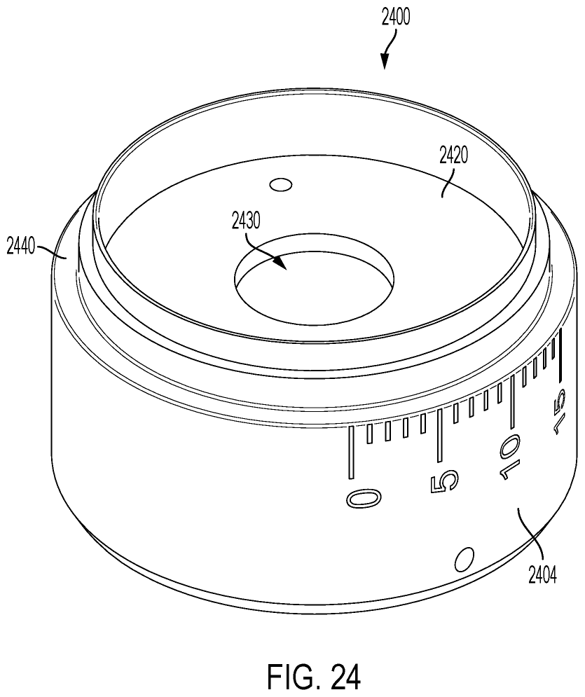

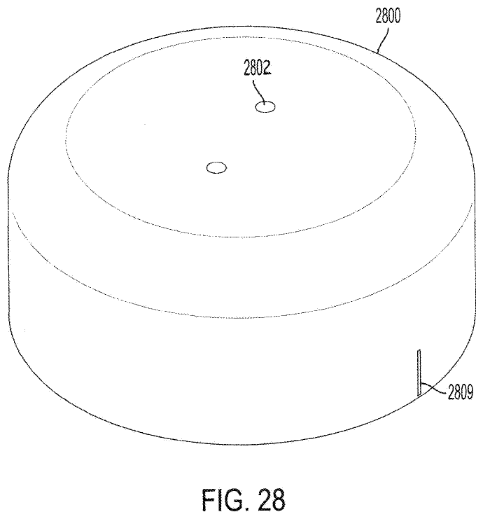

FIG. 24 is a diagram of an example main body or other housing portion 2400 of a tea steeping device according to an embodiment of the present invention. The main body 2400 comprises a surface 2420 for holding and securing a timer unit assembly and an opening 2430 allowing for connection between a timer unit assembly and a tea container. The main body 2400 further comprises a ridge 2440 configured to receive a top cap (e.g., top cap 2800 of FIG. 28). The main body 2004 further comprises an exterior wall 2404 configured to surround at least a portion of a tea container for storage and/or during a steeping process. According to some embodiments, the exterior wall 2404 may comprise one or more openings in accordance with a desired implementation, and may comprise, as shown in FIG. 24, timer indicators for use in setting a timer to a desired period of time.

FIG. 28 is a diagram of an example top cap 2800 of a tea steeping device according to an embodiment of the present invention and comprises one or more openings 2802 for affixing the top cap 2800 to a timer unit (e.g., timer unit assembly 400) of a tea steeping device and may further comprise a timer indicator 2809 for use in setting a timer of a tea steeping device.

As shown in FIG. 1, the example tea steeping device 100 further comprises a tea container 107 having at least one porous portion 110 (e.g., a piece of mesh adjacent an opening in the exterior wall of the tea container 107). In the embodiment depicted in FIG. 1, the tea container 107 may be aligned in the main body 104 using a screw 112 aligned to move up and down accordingly in slot 114 as the timer is set or winds down.

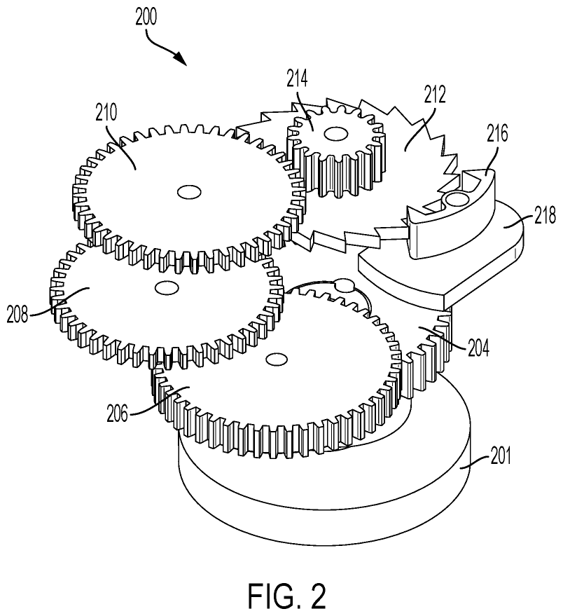

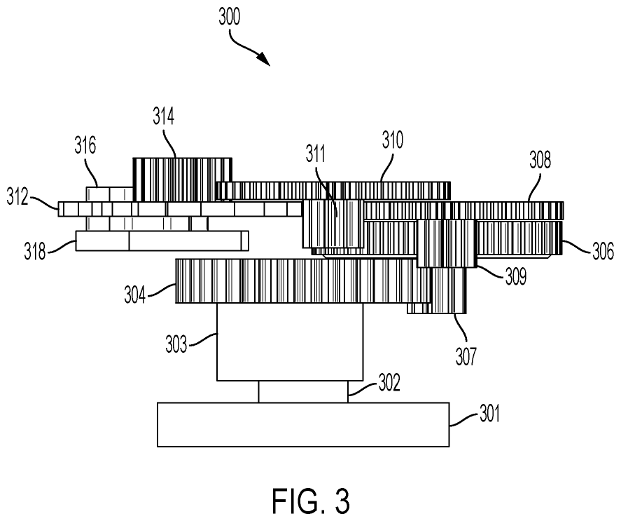

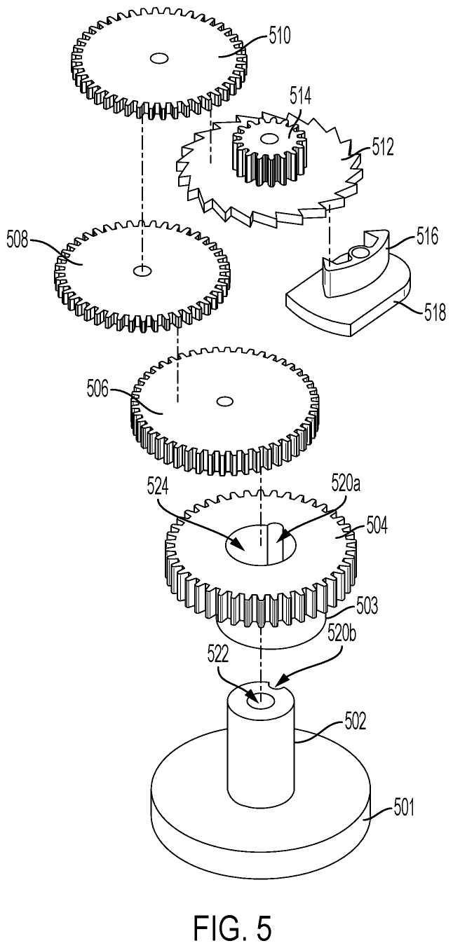

Various types of timers suitable for use with one or more embodiments of the present invention will be known to those skilled in the relevant art. FIG. 2 is a diagram of an example timer configuration 200 of a timing unit according to an embodiment of the present invention; FIG. 3 is another diagram of an example timer configuration 300 of a timer according to an embodiment of the present invention; and FIG. 5 is an exploded view of an example timer configuration 500 of a timer according to an embodiment of the present invention.

According, to the example timer configurations 200 and 300, respective series of geared components allow for a timer to be wound (e.g., to employ the potential energy of a wound internal spring (not shown) to move the timer mechanism) and to communicate mechanically with a connector for driving a blocking portion (e.g., a housing) and/or a steeping material containing portion (e.g., tea container).

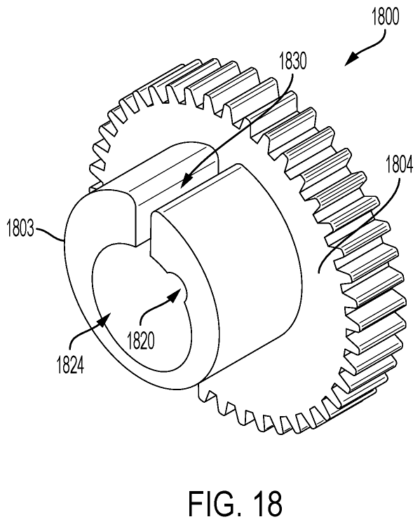

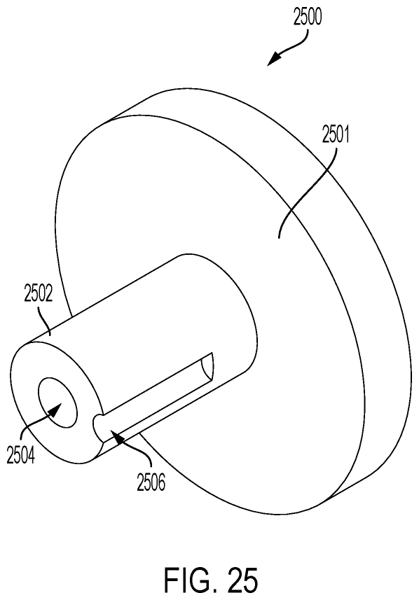

As depicted in the timing gear configuration 200, a center gear guide 201 may be used to retain the timer and/or connect it to other components of a tea steeping device. Similarly, as depicted in the timing gear configuration 300, a center gear guide 301 may be used to retain the timer by inserting shaft 302 into shaft 303, connected to center spring gear 304. FIG. 25 is a diagram of an example center gear guide 2500 according to an embodiment of the present invention and it comprises a base 2501, shaft 2502, center hole 2504, and notch 2506. Center gear guide 201 may connect to a center spring gear 204, for example, by inserting a shaft 2502 in a corresponding slot in center spring gear 204. FIG. 18 is a diagram of an example center spring gear 1800 according to an embodiment of the present invention and it comprises a large gear 1804, shaft 1803, center hole 1824, notch 1820, and spring slot 1830 for receiving and retaining a winding spring (not shown). Center spring gear 204 and center gear guide 201 may be supported by a pin (not shown) inserted where notches 2506 and notch 1820 align.

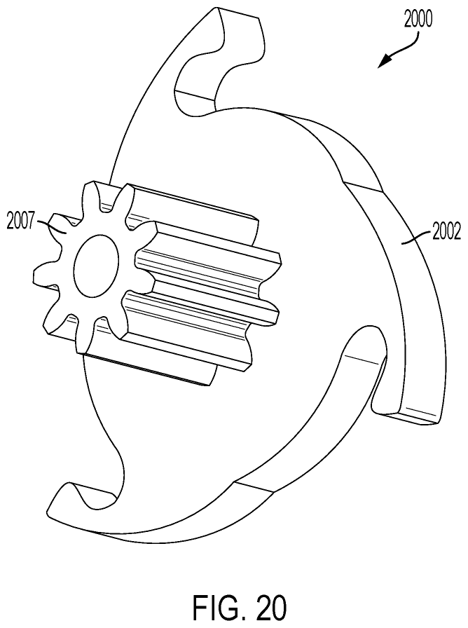

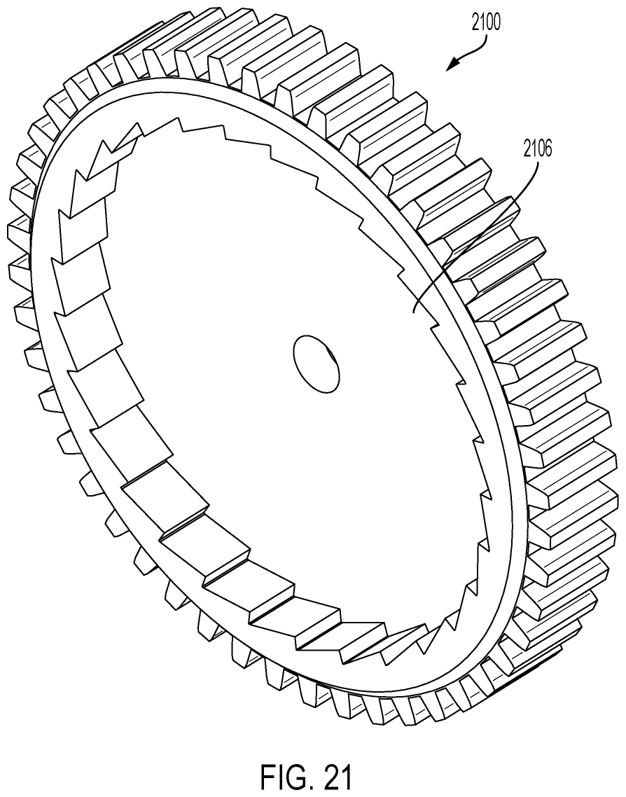

As depicted in the timing gear configuration 200, center spring gear 204 may be engaged with large gear 206. FIG. 21 is a diagram of an example large gear 2100 according to an embodiment of the present invention and it comprises a ratchet holder 2106 for receiving and engaging with a ratchet (not shown in FIG. 2) that engages with center spring gear 204. FIG. 20 is a diagram of an example ratchet 2000 according to an embodiment of the present invention and it comprises a ratchet portion 2002 and a small gear 2007. According to some embodiments, ratchet 2000 is set in the ratchet holder 2106 so that small gear 2007 extends below the large gear 2100 and may engage with other gears. FIG. 3 similarly shows how a ratchet 307 set in a large gear 306 may engage with center spring gear 304.

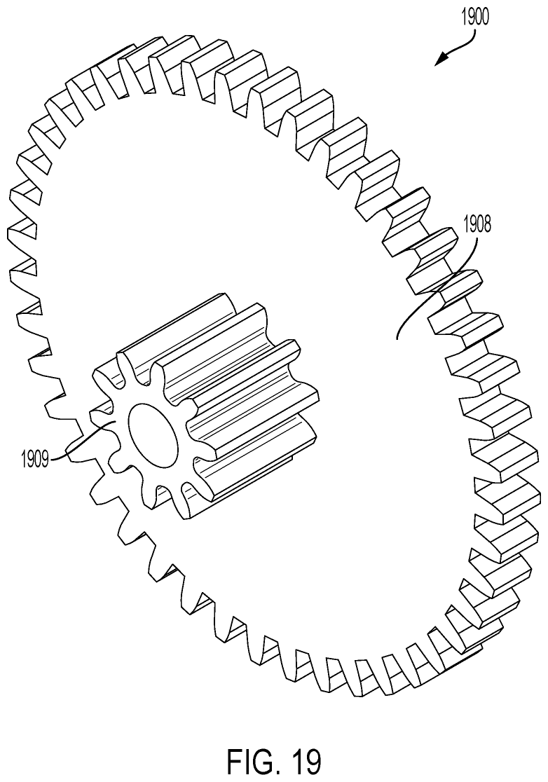

In accordance with the timing gear configuration 200, a small gear (not shown) of gear 208 engages with the large gear 206. As shown in FIG. 3, small gear 309 engages with large gear 306. Similarly, another small gear (not shown) of gear 210 of timing gear configuration 200 engages with gear 208. As shown in FIG. 3, small gear 311 of gear 310 engages with large gear 308. FIG. 19 is a diagram of an example gear 1900 according to an embodiment of the present invention and it comprises a larger gear 1908 and a smaller gear 1909. A structure similar to gear 1900 may be used, for example as gear 208 and gear 210 (and gear 308 and gear 310), for engaging adjacent gears in the timer unit.

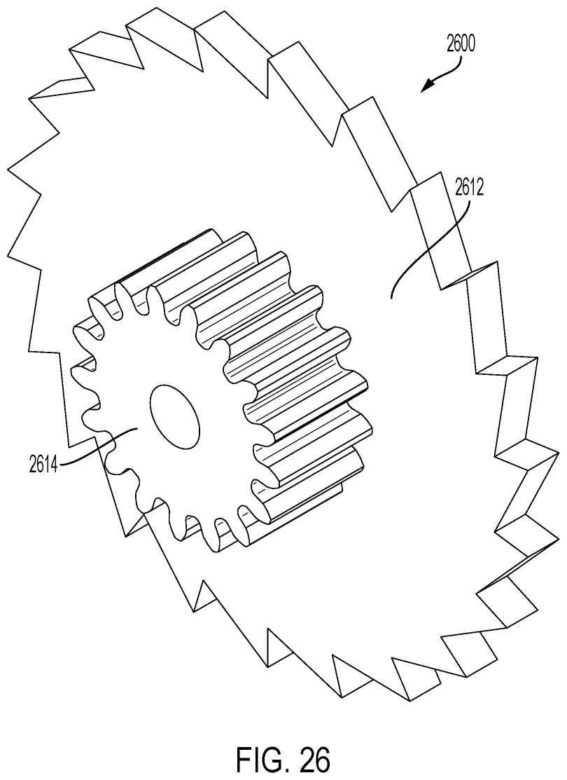

In accordance with the timing gear configuration 200, gear 210 engages with gear 214, attached to ratchet gear 212. Similarly, in accordance with the timing gear configuration 300, gear 310 engages with gear 314, attached to ratchet gear 312. FIG. 26 is a diagram of an example ratchet gear 2600 according to an embodiment of the present invention and it comprises a gear 2614 and a ratchet gear 2612.

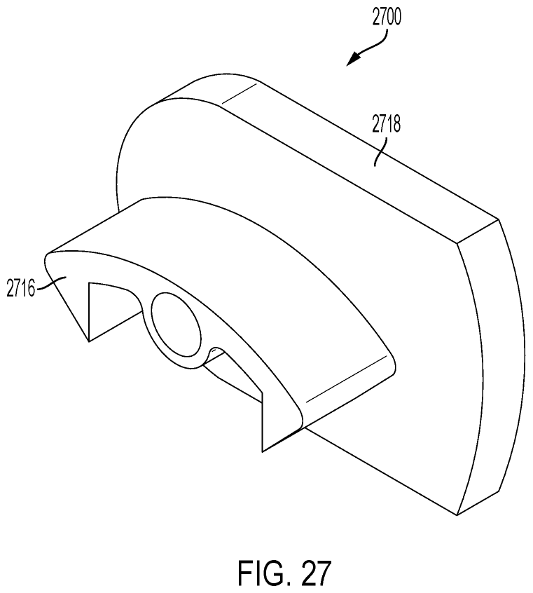

In accordance with the timing gear configuration 200, ratchet gear 212 engages with seconds timer ratchet 216, attached to seconds timer plate 218. Similarly, in accordance with the timing gear configuration 300, ratchet gear 312 engages with seconds timer ratchet 316, attached to seconds timer plate 318. FIG. 27 is a diagram of an example seconds timer 2700 according to an embodiment of the present invention and it comprises seconds timer ratchet 2716 and seconds timer plate 2718.

An example gear configuration 500 is depicted in FIG. 5, showing an example of connections between plate 501, shaft 502, having hole 522 and notch 520b for aligning with notch 520a of center spring gear 504, when shaft 502 is inserted in hole 524 of shaft 503. Gears 504, 506, 508, and 510 may engage one another in a manner similar to that described with respect to similar gears of configurations 200 and 300. Gear 510 may engage with gear 514 to drive engagement of ratchet gear 512 with ratchet 516 attached to plate 518.

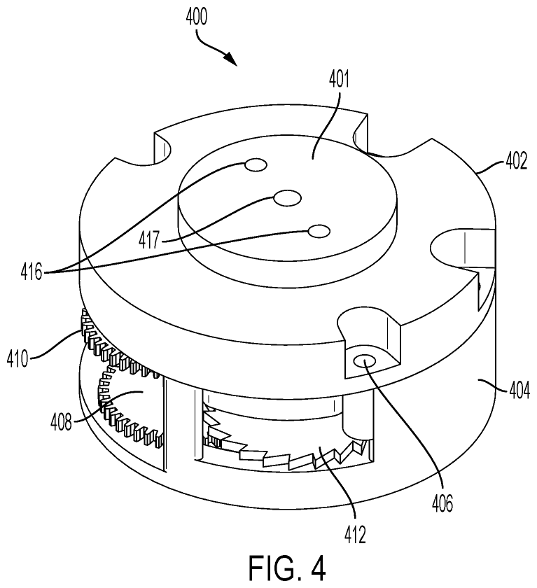

FIG. 4 is a diagram of an example timer unit assembly 400 according to an embodiment of the present invention. In general, the timer unit assembly 400 comprises a timer gear configuration installed in and secured to a top plate 402 and a base plate 404. The top plate 402 may be secured to the base plate 404 using one or more connectors, such as screws, rivets, and/or pins, using one or more aligned openings 406. Example gears 408, 410, and 412 may be seen partially in the interior of the timer unit assembly 400. One or more holes 416 and 417 in the top of plate 401 (e.g., corresponding to the underside of center gear guide 201) may be used to affix the plate 401 to a top cap (not shown) placed over the timer unit assembly 400.

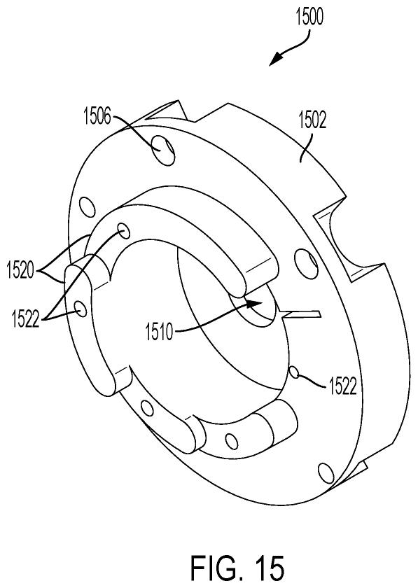

FIG. 15 is a diagram of an example timer unit base 1500 suitable for use in a timer unit assembly (e.g., timer unit assembly 400). The timer unit base 1500 comprises openings 1506, for example, for securing the timer unit base 1500 to a corresponding base plate. The timer unit base 1500 further comprises an opening 1510 for receiving a center gear guide (e.g., center gear guide 201) and one or more slots 1522 for receiving pins or other inserts suitable for securing one or more gear components within a timer unit assembly. According to some embodiments, the slots 1522 may be configured at different heights using one or more support structures 1520 to provide the desired placement for a given gear in a configuration of timer gears.

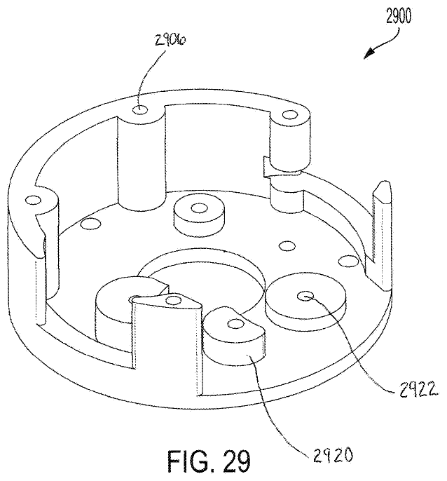

FIG. 29 is a diagram of an example timer unit top plate 2900 suitable for use in a timer unit assembly (e.g., timer unit assembly 400). The timer unit top plate 2900 comprises openings 2906, for example, for securing the timer unit top plate 2900 to a corresponding top plate. The timer unit top plate 2900 further comprises one or more slots 2922 for receiving pins or other inserts suitable for securing one or more gear components within a timer unit assembly. According to some embodiments, the slots 2922 may be configured at different heights using one or more support structures 2920 to provide the desired placement for a given gear in a configuration of timer gears.

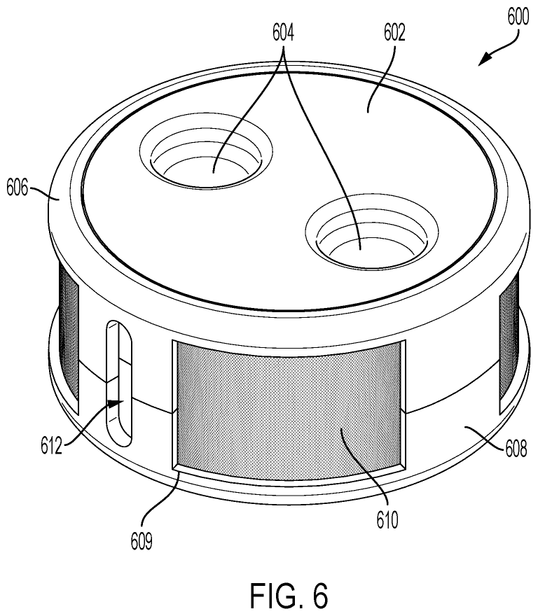

FIG. 6 is a diagram of an example steeping material container portion 600 (also referred to as a “tea container” without limitation as to what type of steeping material may be used with it) according to an embodiment of the present invention. The example assembled steeping material container portion 600 comprises a lid 602 comprising one or more securing/releasing means 604 for removing the lid 602 to access the interior of the tea container 600 and for securing the lid 602 the tea container 600 (e.g., for storage and/or for steeping). The example tea container 600 further comprises a bottom portion 606 connected to a top portion 608; those skilled in the art will understand that the external walls of the tea container 600 may be constructed of a single piece or any number of pieces fit together to form the desired structure. Tea container 600 further comprises at least one opening 609 in the external wall of the tea container 600 that is adjacent to and/or comprises a porous portion 610, such as a piece of metal mesh, for allowing liquid to enter and exit the tea container 600 while retaining any steeping material in the tea container 600.

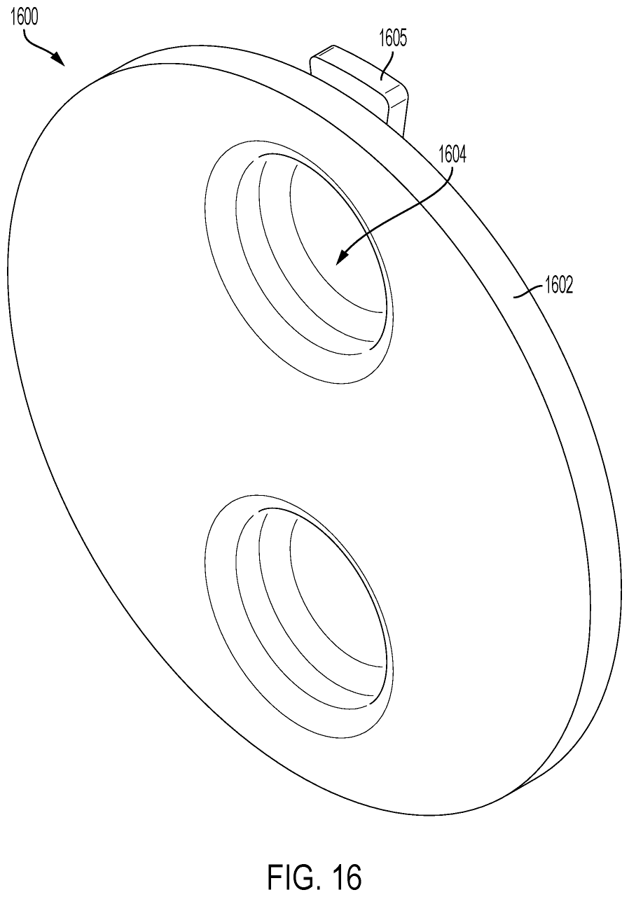

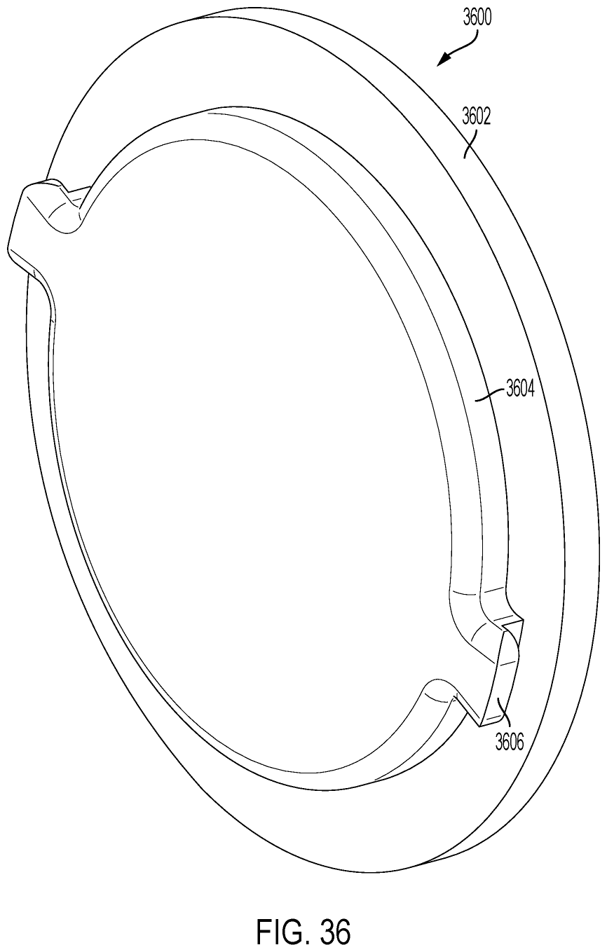

The securing/releasing means 604 may comprise, as in FIG. 6, one or more slots for pressing to release latches under the lid 602. Alternatively, securing/releasing means may comprise one or more finger and/or hand grips for gripping the lid 602 while rotating lid 602 to secure or release it. FIG. 16 depicts an example lid 1600 comprising securing/releasing means 1604 for activating latches 1605 on the underside of cover 1602. FIG. 36 depicts a view of the underside 3604 of an example lid 3600 comprising one or more latches 3606 on the underside of cover 3602 for securing in corresponding gaps in the rim of a tea container.

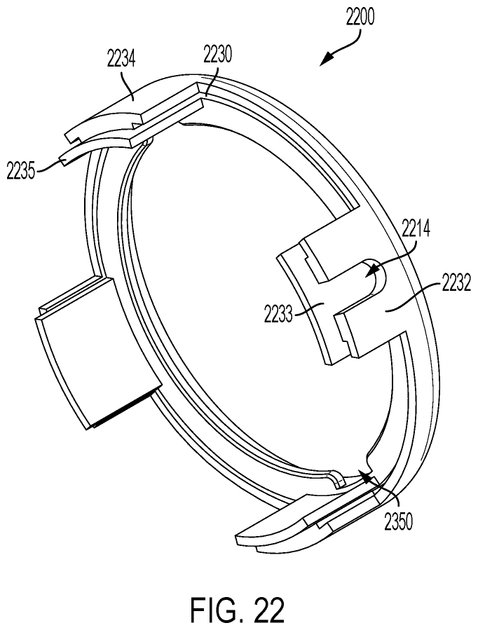

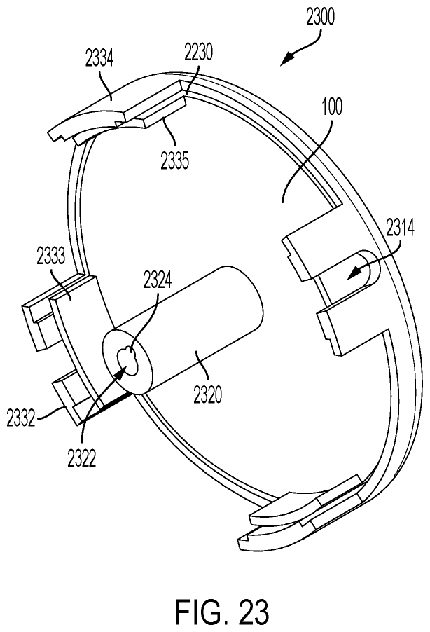

FIG. 22 is a diagram of an example tea container bottom 2200 according to an embodiment of the present invention and FIG. 23 is a diagram of a corresponding example tea container top 2300 according to an embodiment of the present invention. The tea container bottom 2200 comprises one or more guides 2214 that may be used to guide a tea container out of a housing in accordance with some embodiments (e.g., in combination with a corresponding screw, pin, or other object of a housing portion slotted in the guide 2214). The tea container bottom 2200 further comprises one or more exterior portions 2232, 2234 and interior portions 2233, 2235, that may serve, in some embodiments to help secure mesh portions or other types of porous portions in place. In one example, mesh portions may be placed in one or more slots 2230 and abutting exterior portions 2232, 2234 at their ends. The tea container bottom 2200 further comprises one or more notches 2350 for receiving and securing a lid (not shown). Similarly, the tea container top 2300 comprises one or more corresponding guides 2314 that align with guides of 2214 to guide movement of a tea container in accordance with some embodiments. The tea container top 2300 further comprises one or more exterior portions 2332, 2334 and interior portions 2333, 2335, that may serve, in some embodiments to help secure mesh portions or other types of porous portions in place. In one example, mesh portions may be placed in one or more slots 2330 and abutting exterior portions 2332, 2334 at their ends. The tea container top 2300 further comprises a shaft 2320 for receiving a connecting screw or shaft; the opening 2322 includes a groove 2324 for receiving a threaded connector.

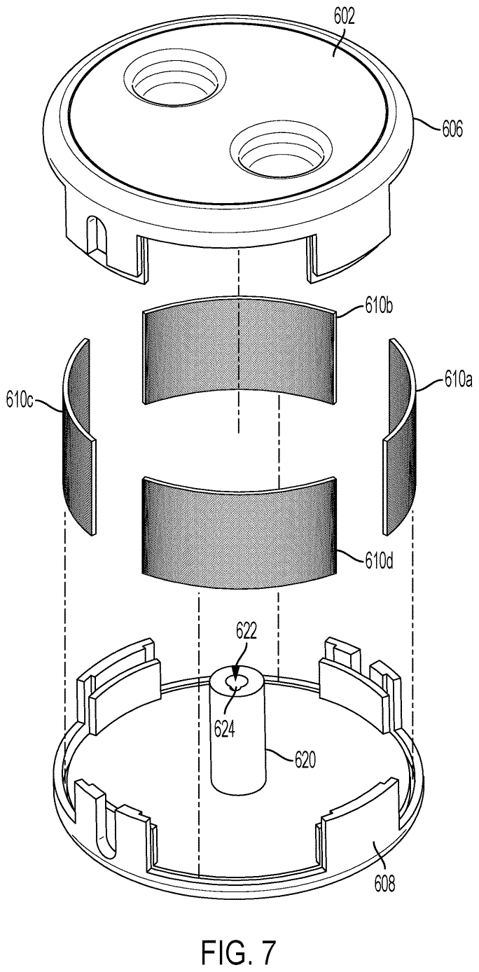

FIG. 7 is an exploded diagram of the example tea container 600 and shows further detail, including mesh portions 610a, 610b, 610c, 610d that sit in corresponding grooves in the top portion 608 and the bottom portion 606 to secure the mesh portions in place. FIG. 7 further shows center shaft 620 having hole 622 and notch 624 for receiving a connecting axle and/or connecting screw (e.g., a connecting screw in mechanical communication with a timer unit).

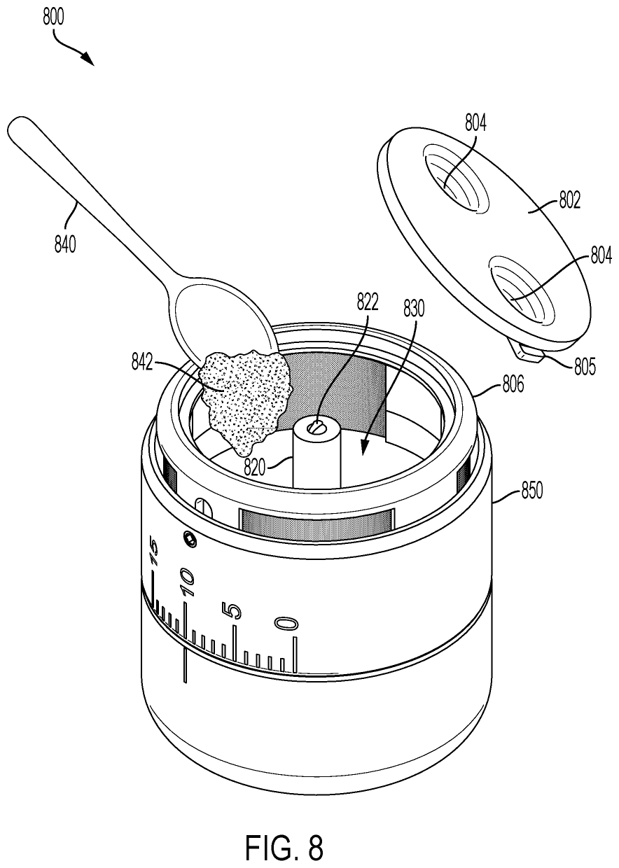

FIG. 8 is a diagram showing an example filling step 800 of an example tea container 806 of a tea steeping device 850 according to an embodiment of the present invention. The lid 802 has been removed using securing/releasing means 804 to release corresponding latch 805, allowing access to interior 830 of the tea container 806. As shown, a spoon 840 is being used to place steeping material 842 in the interior 830 for steeping to prepare a beverage. In the shaft 820 of the tea container 806 a connecting screw 822 may be seen. Once the amount of steeping material 842 is placed according to the user's desire, the lid 802 is preferably replaced and secured to the tea container 806.

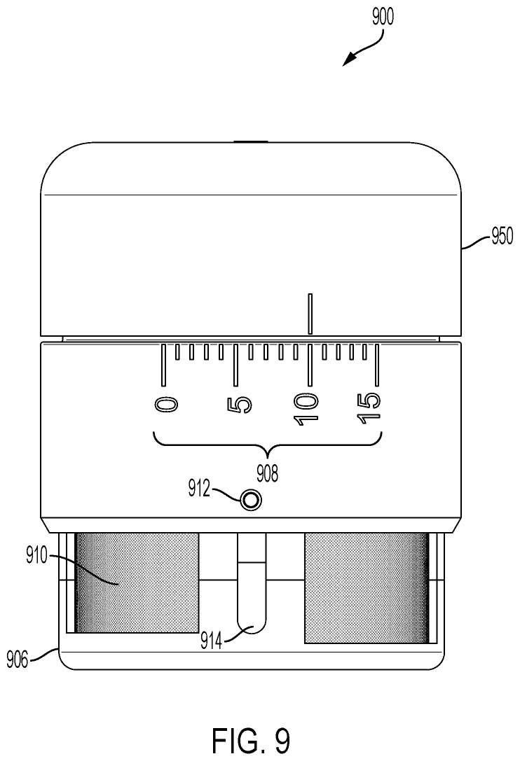

FIG. 9 is a diagram of an example tea steeping device 900 according to an embodiment of the present invention. A housing portion 950 is affixed to a tea container 906 having one or more porous portions 910. As shown, the timer 908 has been set to 10 minutes for steeping, and the tea container 906 is accordingly extended out of the housing portion 950 in preparation for immersion in liquid (e.g., hot water for making tea). The screw 912 is aligned in groove 914 to guide the tea container 906 out of the housing portion 950.

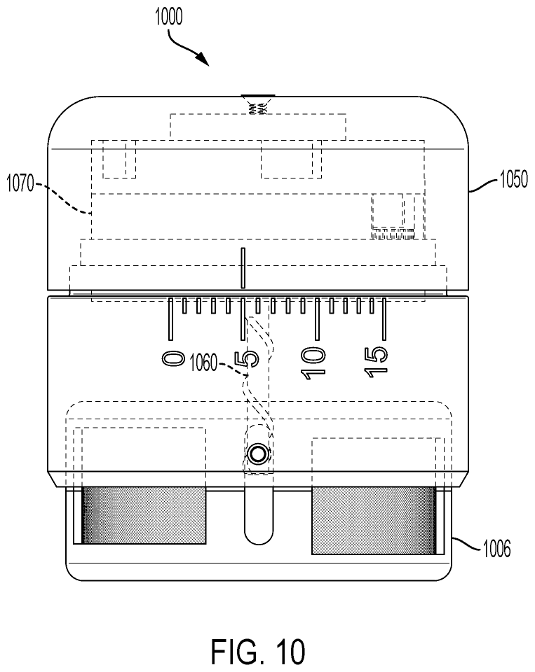

FIG. 10 is a diagram of an alternate view of an example tea steeping device 1000 according to an embodiment of the present invention. An internal timer unit 1070 (e.g., timer unit 400) is indicated inside the housing portion 1050. The timer unit 1070 is connected to the tea container 1006 using an internal connecting screw 1060. In one example, the connecting screw 1060 is threaded in a shaft in the bottom of the tea container 1006 and as the timer is set the screw operates to drive the tea container 1006 out of the housing portion 1050, guided by the screw 1012 aligned in groove 1014.

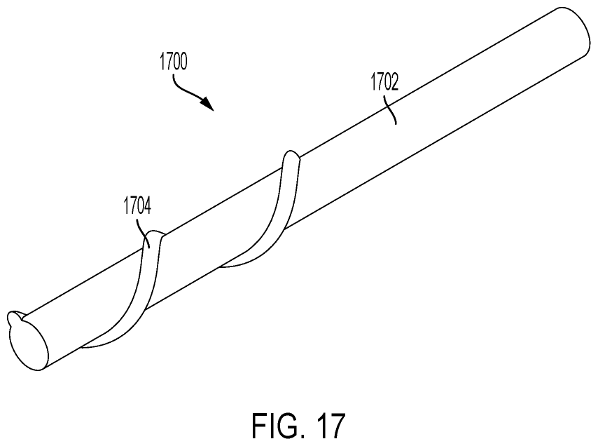

FIG. 17 is a diagram of an example center shaft 1700 according to an embodiment of the present invention, suitable for use in connecting a timer unit to a tea container in accordance with some embodiments. The center shaft 1700 comprises a shaft body 1702 having, on at least a portion of its length, a thread 1704. As discussed with respect to some embodiments, a tea container may be configured (e.g., with a corresponding threaded or grooved shaft) to receive a center shaft having a thread for driving and retracting a tea container from a housing portion during a steeping process.

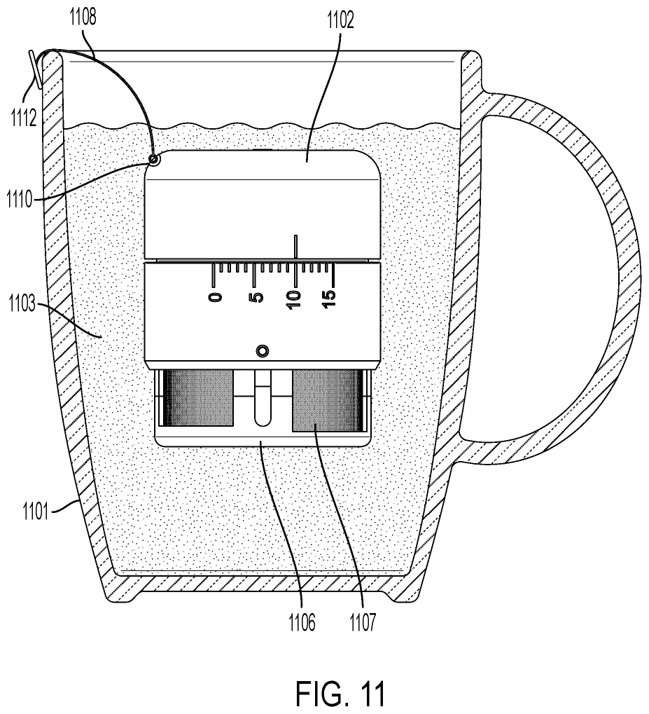

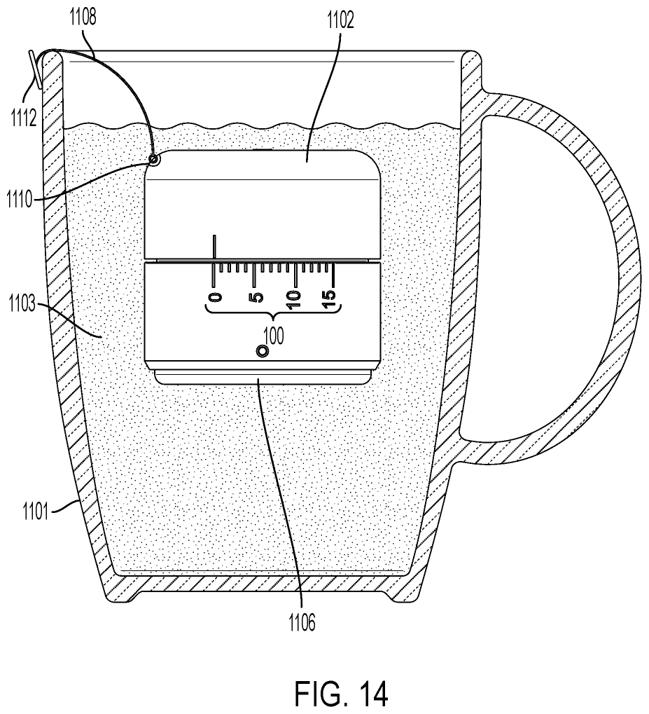

FIGS. 11-14 are a series of diagrams showing an example use of a tea steeping device in a vessel according to an embodiment of the present invention. FIG. 11 shows a tea steeping device 1102 immersed in liquid 1103 (e.g., hot water) in a vessel 1101 (e.g., a mug). Steeping material has been placed in the tea container 1106 and the timer set for period of 10 minutes; in accordance with some embodiments, the tea container 1106 is accordingly extended out of the housing of the tea steeping device 1102. Porous portions 1107 of tea container 1106 are accordingly exposed to liquid 1103, which is free to flow into and out of the tea container 1106, steeping the steeping material contained in it.

FIG. 11 also shows an optional feature of an example tether 1108 loosely connecting the tea steeping device 1102 to the lip of the vessel 1101 using a disc, hook, mild adhesive, or other type of catch 1112. The other end of the tether 1108 is secured to the tea steeping device 1102, such as by tying to or running through a hook 1110. The tether 1108 advantageously allows a user to more easily remove the tea steeping device from within a vessel, potentially avoiding hot liquid.

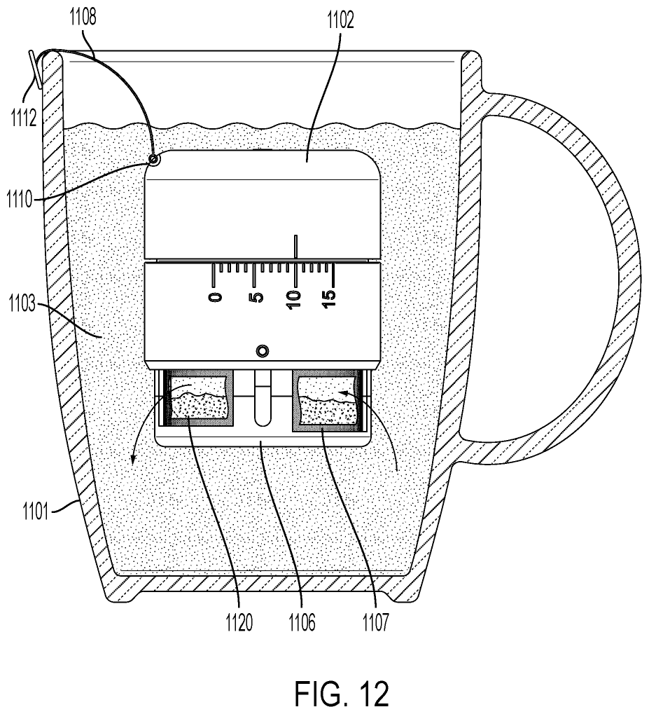

FIG. 12 shows the same state of the steeping process of FIG. 11 but uses cutouts in the porous portion 1107 to show how liquid 1103 is free to pass through the porous portion 1107 and interact with steeping material 1120 to create the desired steeped beverage.

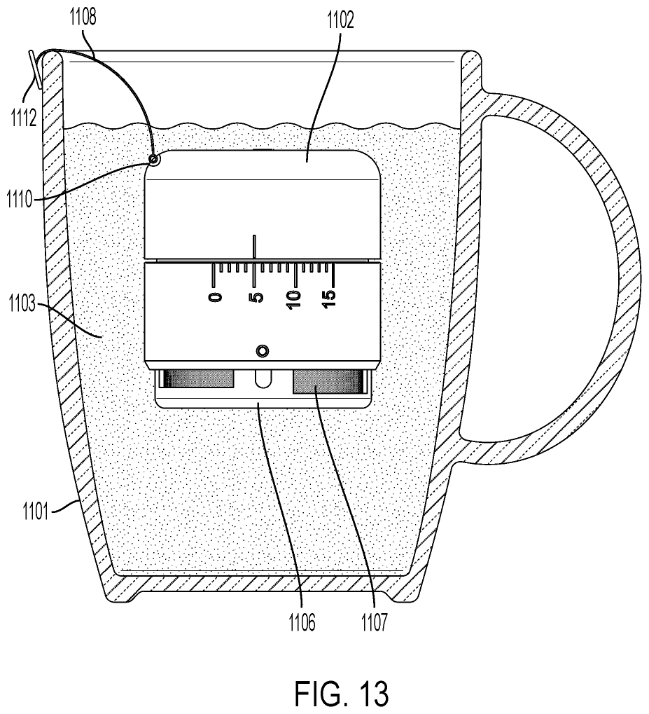

FIG. 13 shows a later stage in the steeping process. In particular, as 5 minutes have expired, the connecting screw (not shown) has operated with the action of the timer unit to draw the tea container back 1106 into the housing of the tea steeping device 1102. In this way, the flow of liquid 1103 in and out of the tea container 1106 is lessened, reducing the rate of absorption of the steeping material 1120 into the liquid 1103. FIG. 15 shows a final state of the steeping process, in which the tea container 1106 has fully retracted into the tea steeping device 1102 and steeping has stopped; specifically, any liquid carrying elements of steeping material 1120 cannot exit the interior of the tea container 1106 anymore.

Some embodiments described in this disclosure involve a tea container that is moved out of a housing or other type of blocking portion to initiate a steeping process and moves into a housing portion to terminate the steeping process (e.g., when a timer ends). Other types of tea steeping device configurations provide for containing a tea container within a housing portion during steeping but still provide blocking or otherwise managing the flow of liquid in and out of a tea container in accordance with a timer.

In one or more embodiments, a tea container having a porous portion in its exterior wall is involved in a steeping process controlled by whether a housing portion in which the tea container is contained allows the flow of liquid to/from the porous portion of the tea container. For example, a housing portion may allow for steeping when an opening in its exterior wall is aligned with the porous portion, and halt steeping when the opening is not aligned with the porous portion. Motion of either the tea container, the housing portion, or both, may be used to put the porous portion and the exterior opening into and out of alignment (e.g., in accordance with action of a timer unit).

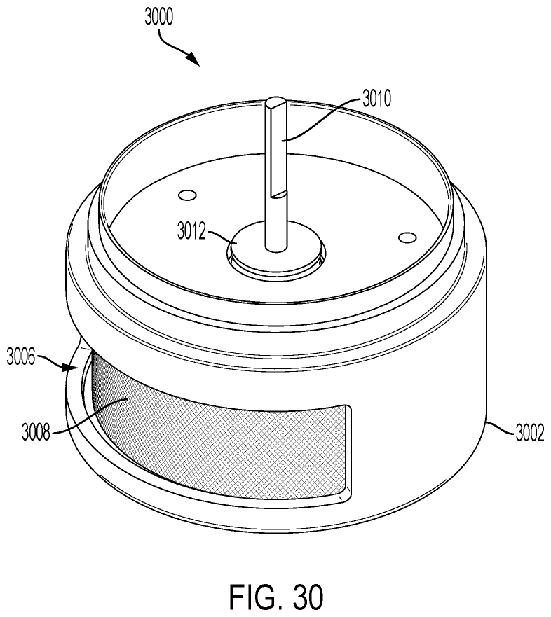

FIG. 30 is a diagram of an example assembly 3000 including a main body 3002 and tea container (not fully shown) of an example tea steeping device according to an alternative embodiment of the present invention. As shown in FIG. 30, the assembly 3000 comprises a main body 3002 having a window or exterior opening 306 in its exterior wall. As shown, a mesh portion or other type of porous portion 3008 may be aligned with the opening 306, allowing for liquid to interact with any steeping material contained in the tea container. A connector 3012 may be in mechanical and/or magnetic connection with the tea container, while a shaft 3010 is configured to connect the connector 3012 with a timer unit. Accordingly, operation of a timer unit may be used to rotate a tea container within the main body 3002. Additional details of a tea container suitable for use with example assembly 3000 are discussed below.

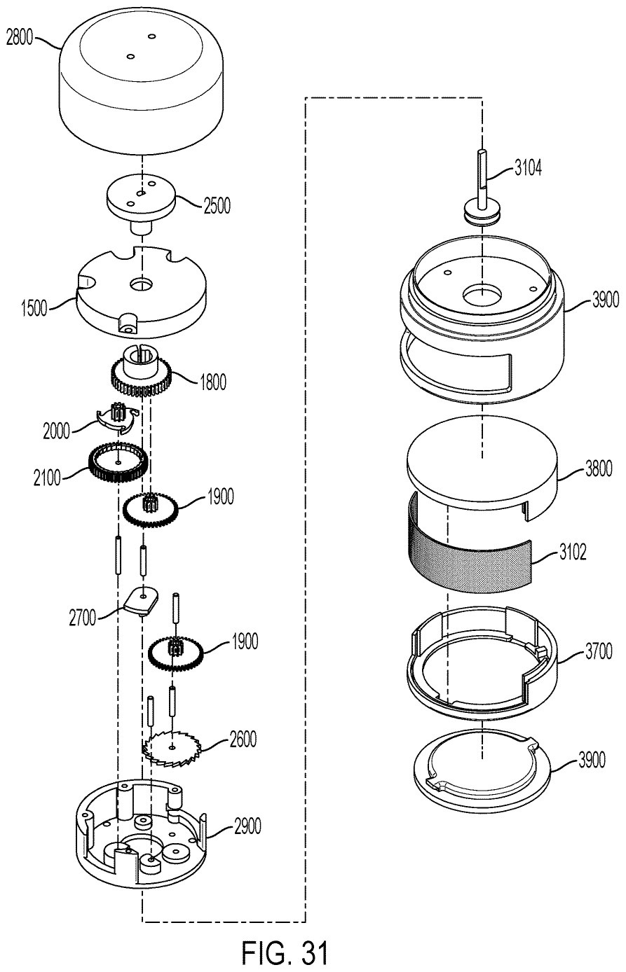

FIG. 31 is an exploded diagram of an example tea steeping device according to an alternative embodiment of the present invention. As shown, the tea steeping device comprises example timer unit assembly components discussed above with respect to FIGS. 2-5. The example tea steeping device further comprises connector 3104 (similar to connector 3012 discussed above), main body 3900, tea container top 3800, mesh portion 3102, tea container bottom 3700, and lid 3600 (discussed above).

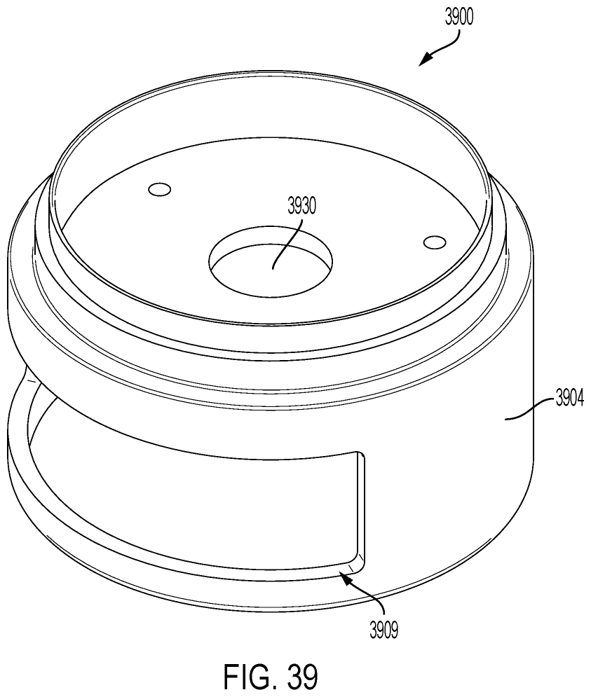

FIG. 39 is a diagram of an example main body 3900 of a tea steeping device according to an alternative embodiment of the present invention. As shown in FIG. 39, the main body 3900 comprises an exterior wall 3904 having at least one opening 3909 for allowing flow of liquid into through the exterior wall 3904. The main body 3900 further comprises opening 3930 for allowing mechanical and/or magnetic connection between a timer unit and a tea container contained in the main body 3900.

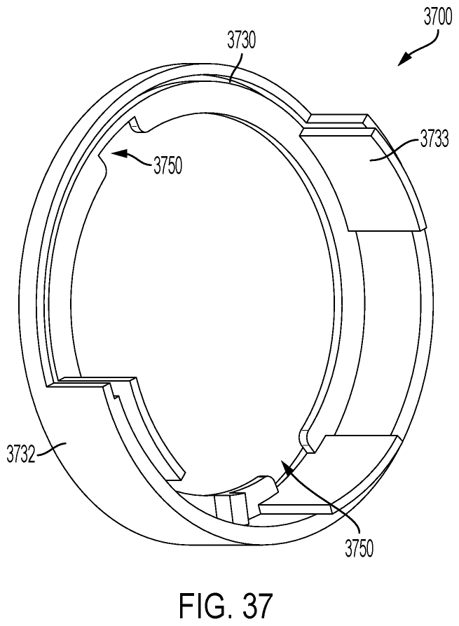

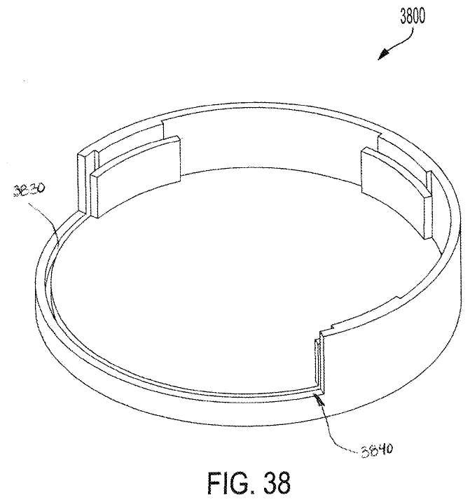

FIG. 37 is a diagram of an example tea container bottom 3700 according to an alternative embodiment of the present invention and FIG. 38 is a diagram of a corresponding example tea container top 3800 according to an alternative embodiment of the present invention. Tea container bottom 3700 is similar to tea container bottom 2200 (FIG. 22) but differs in that it has one (relatively larger) opening in its exterior wall 3732 in which a porous portion (e.g., piece of mesh) may be set in slot 3730. Tea container bottom 3700 further comprises at least one internal wall 3733 to assist in securing a mesh portion in place. Like tea container bottom 2200, tea container bottom 3700 comprises one or more notches 3750 for securing a lid (e.g., lid 3600) in the opening used for placing steeping material. As shown in FIG. 38, tea container top 3800 comprises an opening 3840 corresponding to the opening in tea container bottom 3700 and a corresponding slot 3830 for installing a porous portion.

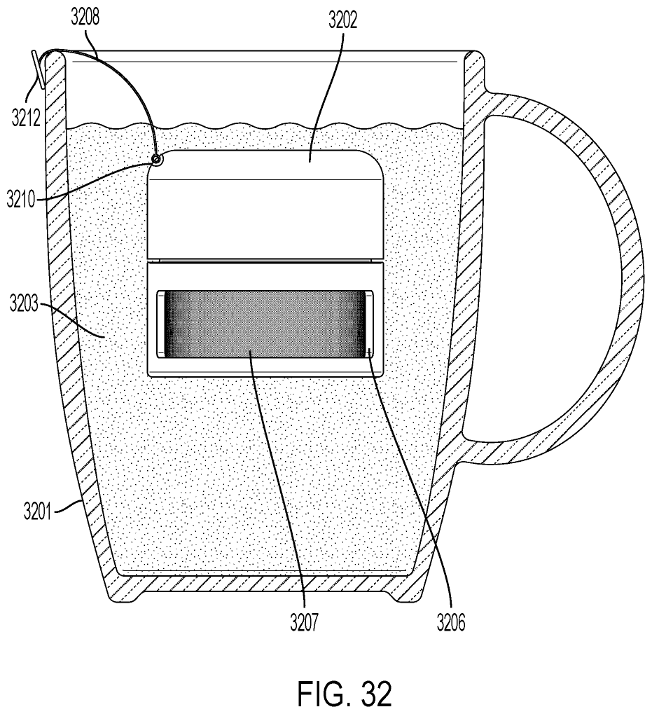

FIGS. 32-35 are a series of diagrams showing an example use of a tea steeping device in a vessel according to an alternative embodiment of the present invention. FIG. 32 shows a tea steeping device 3202 immersed in liquid 3203 (e.g., hot or cold water) in a vessel 3201 (e.g., a mug).

Steeping material has been placed in the tea container (not shown) and the timer (not shown) set for a desired; in accordance with one or more embodiments, the exterior window 3206 is accordingly aligned with porous portion 3207 of the tea container. The porous portion 3207 is accordingly exposed to liquid 3203, which is free to flow into and out of the tea container through the porous portion 3207, steeping the steeping material contained in it.

Like FIG. 12, FIG. 32 also shows an optional feature of an example useful tether 3208 having a catch 3212 and secured to the tea steeping device 3202 by tying it to a hook 3210.

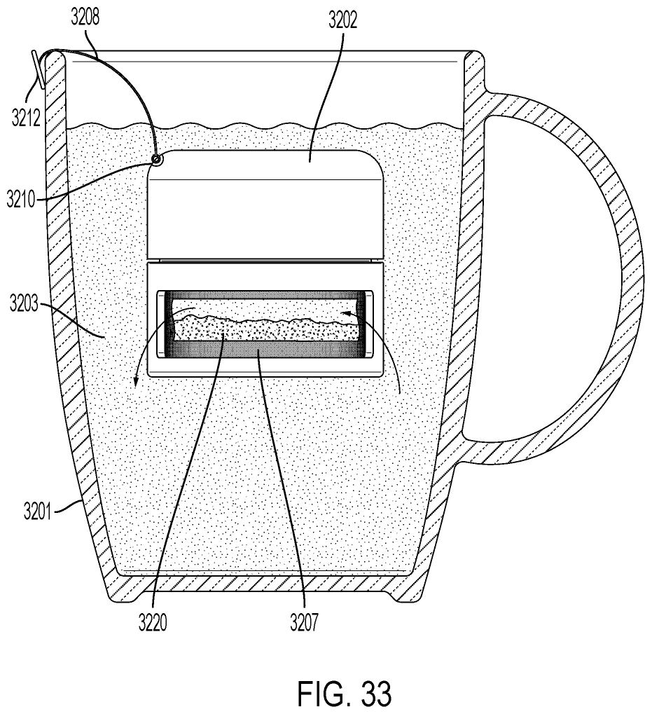

FIG. 33 shows the same state of the steeping process of FIG. 32 but uses a cutout in the porous portion 3207 to show how liquid 3203 is free to pass through the porous portion 3207 and interact with steeping material 3220 in the tea container to create the desired steeped beverage.

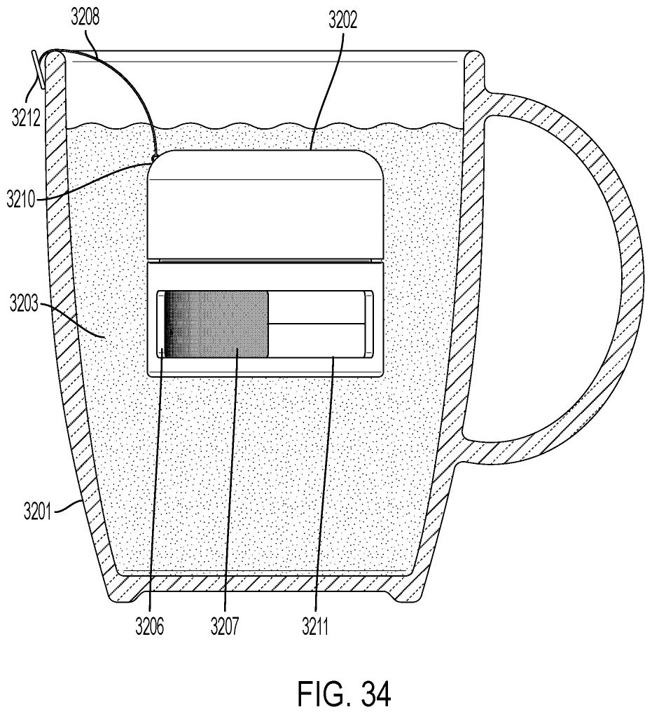

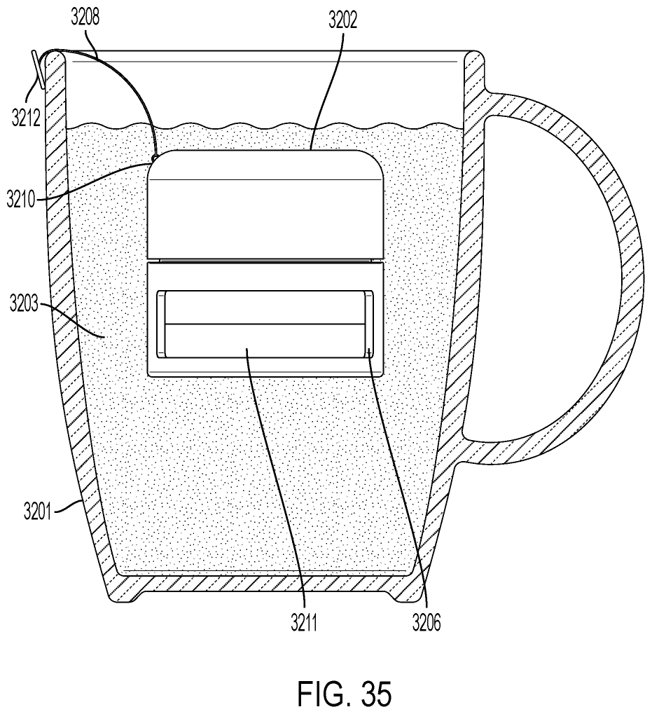

FIG. 34 shows a later stage in the steeping process. In particular, the timer has started to wind down, connector 3104 (not shown) in magnetic and/or mechanical communication with the tea container has operated with the action of the timer unit (not shown) to rotate the tea container within the housing portion of the tea steeping device 3202 so that a part of the porous portion 3207 has rotated away from the exterior window 3206 and now a portion of the tea container's exterior wall 3211 is visible. In this way, the flow of liquid 3203 in and out of the tea container through porous portion 3207 is lessened, reducing the rate of absorption of the steeping material 3220 into the liquid 3203. FIG. 35 shows a final state of the steeping process, in which the porous portion 3207 of the tea container has rotated fully away from the exterior window 3206, only the tea container's exterior wall 3211 is visible, and steeping has accordingly stopped. Specifically, any liquid carrying elements of steeping material 3220 cannot exit the interior of the tea container anymore.

### INTERPRETATION

Numerous embodiments are described in this patent application and are presented for illustrative purposes only. The described embodiments are not, and are not intended to be, limiting in any sense. The presently disclosed invention(s) are widely applicable to numerous embodiments, as is readily apparent from the disclosure. One of ordinary skill in the art will recognize that the disclosed invention may be practiced with various modifications and alterations, such as structural, logical, software, and/or electrical modifications. Although particular features of the disclosed invention(s) may be described with reference to one or more particular embodiments and/or drawings, it should be understood that such features are not limited to usage in the one or more particular embodiments or drawings with reference to which they are described, unless expressly specified otherwise.

The present disclosure is neither a literal description of all embodiments nor a listing of features that must be present in all embodiments.

Neither the Title (as may be set forth at the beginning of the first page of this disclosure) nor the Abstract (as may be set forth at the end of this disclosure) is to be taken as limiting in any way the scope of the disclosed invention(s).

Throughout the description and unless otherwise specified, the following terms may include and/or encompass the example meanings provided below. These terms and illustrative example meanings are provided to clarify the language selected to describe embodiments both in the specification and in the appended claims, and accordingly, are not intended to be limiting.

The terms “an embodiment”, “embodiment”, “embodiments”, “the embodiment”, “the embodiments”, “one or more embodiments”, “some embodiments”, “one embodiment” and the like mean “one or more (but not all) disclosed embodiments”, unless expressly specified otherwise.

The terms “the invention” and “the present invention” and the like mean “one or more embodiments of the present invention.”

A reference to “another embodiment” in describing an embodiment does not imply that the referenced embodiment is mutually exclusive with another embodiment (e.g., an embodiment described before the referenced embodiment), unless expressly specified otherwise.

The terms “including”, “comprising” and variations thereof mean “including but not limited to”, unless expressly specified otherwise.

The terms “a”, “an” and “the” mean “one or more”, unless expressly specified otherwise.

The term “plurality” means “two or more”, unless expressly specified otherwise.

The term “herein” means “in the present disclosure, including anything which may be incorporated by reference”, unless expressly specified otherwise.

The phrase “at least one of”, when such phrase modifies a plurality of things (such as an enumerated list of things) means any combination of one or more of those things, unless expressly specified otherwise. For example, the phrase at least one of a widget, a car and a wheel means either (i) a widget, (ii) a car, (iii) a wheel, (iv) a widget and a car, (v) a widget and a wheel, (vi) a car and a wheel, or (vii) a widget, a car, and a wheel.

The phrase “based on” does not mean “based only on”, unless expressly specified otherwise. In other words, the phrase “based on” describes both “based only on” and “based at least on”.

Where a limitation of a first claim would cover one of a feature as well as more than one of a feature (e.g., a limitation such as “at least one widget” covers one widget as well as more than one widget), and where in a second claim that depends on the first claim, the second claim uses a definite article “the” to refer to the limitation (e.g., “the widget”), this does not imply that the first claim covers only one of the feature, and this does not imply that the second claim covers only one of the feature (e.g., “the widget” can cover both one widget and more than one widget).

Each process (whether called a method, algorithm or otherwise) inherently includes one or more steps, and therefore all references to a “step” or “steps” of a process have an inherent antecedent basis in the mere recitation of the term “process” or a like term. Accordingly, any reference in a claim to a “step” or “steps” of a process has sufficient antecedent basis.

When an ordinal number (such as “first”, “second”, “third” and so on) is used as an adjective before a term, that ordinal number is used (unless expressly specified otherwise) merely to indicate a particular feature, such as to distinguish that particular feature from another feature that is described by the same term or by a similar term. For example, a “first widget” may be so named merely to distinguish it from, e.g., a “second widget”. Thus, the mere usage of the ordinal numbers “first” and “second” before the term “widget” does not indicate any other relationship between the two widgets, and likewise does not indicate any other characteristics of either or both widgets. For example, the mere usage of the ordinal numbers “first” and “second” before the term “widget” (1) does not indicate that either widget comes before or after any other in order or location; (2) does not indicate that either widget occurs or acts before or after any other in time; and (3) does not indicate that either widget ranks above or below any other, as in importance or quality. In addition, the mere usage of ordinal numbers does not define a numerical limit to the features identified with the ordinal numbers. For example, the mere usage of the ordinal numbers “first” and “second” before the term “widget” does not indicate that there must be no more than two widgets.

As used in this disclosure, a “user” may generally refer to any individual and/or entity that operates a user device.

A description of an embodiment with several components or features does not imply that any particular one of such components and/or features is required. On the contrary, a variety of optional components are described to illustrate the wide variety of possible embodiments of the present invention(s). Unless otherwise specified explicitly, no component and/or feature is essential or required.

Further, although process steps, algorithms or the like may be described or depicted in a sequential order, such processes may be configured to work in one or more different orders. In other words, any sequence or order of steps that may be explicitly described or depicted does not necessarily indicate a requirement that the steps be performed in that order. The steps of processes described in this disclosure may be performed in any order practical. Further, some steps may be performed simultaneously despite being described or implied as occurring non-simultaneously (e.g., because one step is described after the other step). Moreover, the illustration of a process by its depiction in a drawing does not imply that the illustrated process is exclusive of other variations and modifications, does not imply that the illustrated process or any of its steps is necessary to the invention, and does not imply that the illustrated process is preferred.

While the present invention has been illustrated by a description of various embodiments and while these embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and method, and illustrative examples shown and described. Accordingly, departures may be made from such details without departing from the spirit or scope of the general inventive concept.

The present disclosure provides, to one of ordinary skill in the art, an enabling description of several embodiments and/or inventions. Some of these embodiments and/or inventions may not be claimed in the present application but may nevertheless be claimed in one or more continuing applications that claim the benefit of priority of the present application. Applicant reserves the right to file additional applications to pursue patents for subject matter that has been disclosed and enabled but not claimed in the present application.

What is claimed is:

1. A device comprising:
a timer;
a steeping material containing portion having an exterior configured to allow passage of liquid through the exterior of the steeping material containing portion; and
one or more blocking portions connected to the timer and configured to prevent the passage of liquid through the exterior of the steeping material containing portion.

2. The device of claim 1, wherein the one or more blocking portions is configured with the timer to block access to the interior of the steeping material containing portion on expiration of a timed period.

3. The device of claim 1, wherein the steeping material containing portion comprises a mesh portion.

4. The device of claim 1, wherein the steeping portion is substantially cylindrical in shape.

5. The device of claim 1, wherein a shape of the steeping portion is substantially rectangular, square, pyramidal, or spherical in shape.

6. A device for steeping tea comprising:
a timer configured with a dial to allow a user to set the timer for a desired period of time;
a steeping material containing portion for containing steeping material and having at least one mesh portion; and
a blocking portion in mechanical communication with the timer and the steeping material containing portion and configured to overlap the steeping material containing portion in accordance with operation of the timer.

7. The device of claim 6, wherein the at least one mesh portion allows the passage of liquid into and out of the steeping material containing portion for steeping the steeping material.

8. A device comprising:
a timer;
a tea container connected to the timer and having an exterior configured to allow passage of liquid through the exterior of the tea container and an interior portion configured to contain steeping material; and
a housing configured to contain the tea container and, based on operation of the timer, to block the passage of liquid through the exterior of the tea container.

9. The device of claim 8, wherein the housing is connected to the timer.

10. The device of claim 8, wherein the housing comprises timer indicia for setting the timer.

11. The device of claim 8, wherein the housing comprises an open end for receiving or extending the tea container during a steeping process.

12. The device of claim 8, wherein the housing comprises a first opening to allow passage of liquid through the exterior of the housing and the tea container comprises a second opening to allow passage of liquid through the exterior of the tea container.

13. The device of claim 12, wherein when the timer is set, the first opening is aligned with the second opening to allow passage of liquid through the first opening and the second opening and into the interior of the tea container.

14. The device of claim 12, wherein as the timer winds down, the timer rotates the tea container within the housing such that a smaller portion of the second opening is aligned with the first opening, thereby restricting the passage of liquid into the interior of the tea container.

15. The device of claim 8, wherein the timer is connected magnetically to the tea container via a connecting axle.

16. The device of claim 8, wherein the timer is connected magnetically to the tea container.

17. The device of claim 8, wherein the timer is connected mechanically to the tea container using a connecting screw.

18. The device of claim 17, wherein when the timer is set, the corresponding operation of the connecting screw extends the tea container out of the housing.

19. The device of claim 17, wherein as the timer winds down, the corresponding operation of the connecting screw retracts the tea container out of the housing.

20. The device of claim 8, wherein the tea container is configured with at least one mesh portion allowing passage of liquid into the interior of the tea container.

21. A method of steeping tea using a tea steeping device comprising a timer, a tea container connected to the timer and having a porous portion, and a housing configured for containing the tea container, the method comprising:
placing tea material in the tea container;
exposing the porous portion of the tea container by setting the timer;
placing the tea steeping device in liquid contained in a vessel, thereby allowing the liquid to pass through the porous portion into the tea container to steep the tea material;
allowing the timer to wind down and cause the housing to block passage of the liquid through the porous portion, thereby preventing passage of liquid in and out of the tea container and ending the steeping.

22. The method of claim 21, wherein causing the housing to block passage of the liquid through the porous portion comprises retracting the tea container into the housing.

23. The method of claim 21, wherein the tea container is contained in the housing during the entirety of the steeping and wherein causing the housing to block passage of the liquid through the porous portion comprises rotating the porous portion away from an opening in the housing.
